(19) United States
(12) Patent Application Publication
(10) Pub. No.: US 2006/0004589 A1
(43) Pub. Date: Jan. 5, 2006

(54) Method for mileage based proactive leasing in a telematics system

(75) Inventors: Steven J. Ross, Madison Heights, MI (US); Edward P. Chrumka, Grosse Pointe Park, MI (US); Jeffrey G. Ravas, Oxford, MI (US); Nathan D. Ampunan, West Bloomfield, MI (US); Gary A. Watkins, Royal Oak, MI (US)

Correspondence Address: General Motors Corporation;Legal Staff, Mail Code 482-C23-B21, 300 Renaissance Center, P.O. Box 300, Detroit, MI, 48265-3000, US

(73) Assignee: General Motors Corporation

(21) Appl. No.: 10/883,926

(22) Filed: Jul. 2, 2004

(51) Int. Cl. G06F 17/60

(52) U.S. Cl. 705/1

(57) ABSTRACT

A method of operating a vehicle leasing program. The method includes receiving a mileage value from a vehicle at a call center determining whether the mileage value corresponds to a leasing event trigger and notifying a user of the vehicle of a leasing event responsive to the determination.

### FIELD OF THE INVENTION

This invention relates generally to a vehicle leasing program in telematics systems. In particular, the invention relates to a method, system and computer usable medium for monitoring mileage in a leased vehicle to proactively provide leasing options.

### BACKGROUND OF THE INVENTION

The opportunity to personalize features in a mobile vehicle is ever increasing as the automobile is being transformed into a communications and entertainment platform as well as a transportation platform. Many new cars will be installed with some type of telematics unit to provide wireless communication and location-based services. These services may be accessed through interfaces such as voice-recognition computer applications, touch-screen computer displays, computer keyboards, or a series of buttons on the dashboard or console of a vehicle.

Currently, telematics service call centers, in-vehicle compact disk (CD) or digital video display (DVD) media, web portals, and voice-enabled phone portals provide various types of location services, including driving directions, stolen vehicle tracking, traffic information, weather reports, restaurant guides, ski reports, road condition information, accident updates, street routing, landmark guides, and business finders.

For example, traffic and driving directions may be accessed through a voice portal that uses incoming number identification to generate location information responsive to the area code or prefix of the phone number, or to access location information stored in a user's profile associated with the phone number. Users may be prompted to enter more details through a voice interface. Other examples are web and wireless portals that offer location-based services such as maps and driving directions where the user enters both a start and end addresses. Some of these services may have a voice interface.

Vehicle leasing programs often include a limit on the total miles that a vehicle can be driven during the lifetime of the lease contract. If the lessee exceeds such a limit, additional costs or penalties may be assessed by the lessor. In some cases there is a comparatively high charge for every mile over the mileage limit. A driver of a leased vehicle can remember to watch the odometer to regulate the total miles driven, in order to avoid the additional charge. In some leasing programs the driver can access a web site to input the current odometer reading to compare the odometer reading with the maximum mileage limit. The driver is responsible to remember to watch the miles in both cases.

In some cases, vehicle leasing departments monitor the odometer readings collected during service visits and inform the driver when the odometer reading is close to the mileage limit of the contract. In that case, the vehicle leasing departments might offer an option to avoid the excess charges. Typically, if the driven miles begin to approach the mileage limit the driver's only option is to regulate the miles driven until the lease contract expires.

It is desirable, therefore, to provide a method, system and computer usable medium that overcomes the limitations described above. It is desirable to allow a driver of a leased vehicle with an installed telematics system to proactively monitor the vehicle mileage over the lifetime of the contract. It is further desirable for the driver to be presented with options to avoid or reduce the lease overage charges at the end of the lease if the total mileage approaches or exceeds the mileage limitation.

### SUMMARY OF THE INVENTION

One aspect of the present invention provides a method of operating a vehicle leasing program. The method includes receiving a mileage value from a vehicle at a call center determining whether the mileage value corresponds to a leasing event trigger and notifying a user of the vehicle of a leasing event responsive to the determination.

Another aspect of the present invention provides a vehicle leasing system. The system includes means for receiving a mileage value from a vehicle at a call center, means for determining whether the mileage value corresponds to a leasing event trigger, and means for notifying a user of the vehicle of a leasing event responsive to the determination.

A third aspect of the present invention provides a computer readable medium storing a computer program which includes computer readable code for receiving a mileage value from a vehicle at a call center, computer readable code for determining whether the mileage value corresponds to a leasing event trigger, and computer readable code for notifying a user of the vehicle of a leasing event responsive to the determination.

The foregoing and other features and advantages of the invention will become further apparent from the following detailed description of the presently preferred embodiment, read in conjunction with the accompanying drawings. The detailed description and drawings are merely illustrative of the invention rather than limiting, the scope of the invention being defined by the appended claims and equivalents thereof.

### BRIEF DESCRIPTION OF THE DRAWINGS

Various embodiments of the present invention are illustrated by the accompanying figures, wherein:

FIG. 1 is a schematic diagram of a system for providing access to a telematics system in a mobile vehicle;

FIG. 2 illustrates a flowchart representative of one embodiment of a method of operating a vehicle leasing program in accordance with the present invention;

FIG. 3 illustrates a flowchart representative of one embodiment of a method of operating a vehicle leasing program in accordance with the present invention;

FIG. 4 illustrates a flowchart representative of one embodiment of a method of operating a vehicle leasing program in accordance with the present invention;

FIG. 5 illustrates a flowchart representative of one embodiment of a method of operating a vehicle leasing program in accordance with the present invention; and

FIG. 6 illustrates one embodiment of a block diagram of a leasing event indicator in accordance with the embodiment of FIG. 5.

### DETAILED DESCRIPTION OF THE PRESENTLY PREFERRED EMBODIMENTS

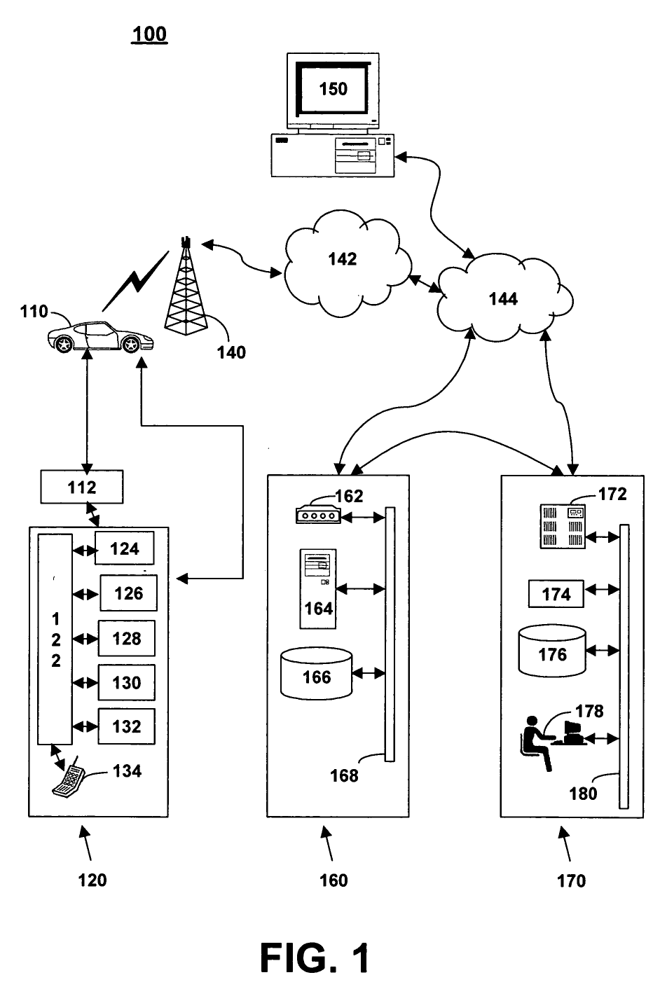

FIG. 1 illustrates one embodiment of system for data transmission over a wireless communication system, in accordance with the present invention at 100. Mobile vehicle communication system (MVCS) 100 includes a mobile vehicle communication unit (MVCU) 110, a vehicle communication network 112, a telematics unit 120, one or more wireless carrier systems 140, one or more communication networks 142, one or more land networks 144, one or more client, personal or user computers 150, one or more web-hosting portals 160, and one or more call centers 170. In one embodiment, MVCU 110 is implemented as a mobile vehicle equipped with suitable hardware and software for transmitting and receiving voice and data communications. MVCS 100 may include additional components not relevant to the present discussion. Mobile vehicle communication systems and telematics units are known in the art.

MVCU 110 may also be referred to as a mobile vehicle throughout the discussion below. In operation, MVCU 110 may be implemented as a motor vehicle, a marine vehicle, or as an aircraft. MVCU 110 may include additional components not relevant to the present discussion.

MVCU 110, via a vehicle communication network 112, sends signals to various units of equipment and systems (detailed below) within MVCU 110 to perform various functions such as unlocking a door, opening the trunk, setting personal comfort settings, and calling from telematics unit 120. In facilitating interactions among the various communication and electronic modules, vehicle communication network 112 utilizes network interfaces such as controller-area network (CAN), International Organization for Standardization (ISO) Standard 9141, ISO Standard 11898 for high-speed applications, ISO Standard 11519 for lower speed applications, and Society of Automotive Engineers (SAE) Standard J1850 for high-speed and lower speed applications.

MVCU 110, via telematics unit 120, sends and receives radio transmissions from wireless carrier system 140. Wireless carrier system 140 is implemented as any suitable system for transmitting a signal from MVCU 110 to communication network 142.

Telematics unit 120 includes a processor 122 connected to a wireless modem 124, a global positioning system (GPS) unit 126, an in-vehicle memory 128, a microphone 130, one or more speakers 132, and an embedded or in-vehicle mobile phone 134. In other embodiments, telematics unit 120 may be implemented without one or more of the above listed components, such as, for example GPS unit 126 or speakers 132. Telematics unit 120 may include additional components not relevant to the present discussion.

In one embodiment, processor 122 is a digital signal processor (DSP). Processor 122 is implemented as a microcontroller, microprocessor, controller, host processor, or vehicle communications processor. In an example, processor 122 is implemented as an application specific integrated circuit (ASIC). In another embodiment, processor 122 is implemented as a processor working in conjunction with a central processing unit (CPU) performing the function of a general purpose processor. GPS unit 126 provides longitude and latitude coordinates of the vehicle responsive to a GPS broadcast signal received from a one or more GPS satellite broadcast systems (not shown). In-vehicle mobile phone 134 is a cellular-type phone, such as, for example an analog, digital, dual-mode, dual-band, multi-mode or multi-band cellular phone.

Processor 122 executes various computer programs that control programming and operational modes of electronic and mechanical systems within MVCU 110. Processor 122 controls communications (e.g. call signals) between telematics unit 120, wireless carrier system 140, and call center 170. In one embodiment, a voice-recognition application is installed in processor 122 that can translate human voice input through microphone 130 to digital signals. Processor 122 generates and accepts digital signals transmitted between telematics unit 120 and a vehicle communication network 112 that is connected to various electronic modules in the vehicle. In one embodiment, these digital signals activate the programming mode and operation modes, as well as provide for data transfers. In this embodiment, signals from processor 122 are translated into voice messages and sent out through speaker 132.

Communication network 142 includes services from one or more mobile telephone switching offices and wireless networks. Communication network 142 connects wireless carrier system 140 to land network 144. Communication network 142 is implemented as any suitable system or collection of systems for connecting wireless carrier system 140 to MVCU 110 and land network 144.

Land network 144 connects communication network 142 to client computer 150, web-hosting portal 160, and call center 170. In one embodiment, land network 144 is a public-switched telephone network (PSTN). In another embodiment, land network 144 is implemented as an Internet protocol (IP) network. In other embodiments, land network 144 is implemented as a wired network, an optical network, a fiber network, other wireless networks, or any combination thereof. Land network 144 is connected to one or more landline telephones. Communication network 142 and land network 144 connect wireless carrier system 140 to web-hosting portal 160 and call center 170.

Client, personal or user computer 150 includes a computer usable medium to execute Internet browser and Internet-access computer programs for sending and receiving data over land network 144 and optionally, wired or wireless communication networks 142 to web-hosting portal 160. Personal or client computer 150 sends user preferences to web-hosting portal through a web-page interface using communication standards such as hypertext transport protocol (HTTP), and transport-control protocol and Internet protocol (TCP/IP). In one embodiment, the data includes directives to change certain programming and operational modes of electronic and mechanical systems within MVCU 110. In operation, a client utilizes computer 150 to initiate setting or re-setting of user-preferences for MVCU 110. User-preference data from client-side software is transmitted to server-side software of web-hosting portal 160. User-preference data is stored at web-hosting portal 160.

Web-hosting portal 160 includes one or more data modems 162, one or more web servers 164, one or more databases 166, and a network system 168. Web-hosting portal 160 is connected directly by wire to call center 170, or connected by phone lines to land network 144, which is connected to call center 170. In an example, web-hosting portal 160 is connected to call center 170 utilizing an IP network. In this example, both components, web-hosting portal 160 and call center 170, are connected to land network 144 utilizing the IP network. In another example, web-hosting portal 160 is connected to land network 144 by one or more data modems 162. Land network 144 sends digital data to and from modem 162, data that is then transferred to web server 164. Modem 162 may reside inside web server 164. Land network 144 transmits data communications between web-hosting portal 160 and call center 170.

Web server 164 receives user-preference data from user computer 150 via land network 144. In alternative embodiments, computer 150 includes a wireless modem to send data to web-hosting portal 160 through a wireless communication network 142 and a land network 144. Data is received by land network 144 and sent to one or more web servers 164. In one embodiment, web server 164 is implemented as any suitable hardware and software capable of providing web services to help change and transmit personal preference settings from a client at computer 150 to telematics unit 120 in MVCU 110. Web server 164 sends to or receives from one or more databases 166 data transmissions via network system 168. Web server 164 includes computer applications and files for managing and storing personalization settings supplied by the client, such as door lock/unlock behavior, radio station preset selections, climate controls, custom button configurations and theft alarm settings. For each client, the web server potentially stores hundreds of preferences for wireless vehicle communication, networking, maintenance and diagnostic services for a mobile vehicle.

In one embodiment, one or more web servers 164 are networked via network system 168 to distribute user-preference data among its network components such as database 166. In an example, database 166 is a part of or a separate computer from web server 164. Web server 164 sends data transmissions with user preferences to call center 170 through land network 144.

Call center 170 is a location where many calls are received and serviced at the same time, or where many calls are sent at the same time. In one embodiment, the call center is a telematics call center, facilitating communications to and from telematics unit 120 in MVCU 110. In an example, the call center is a voice call center, providing verbal communications between an advisor in the call center and a subscriber in a mobile vehicle. In another example, the call center contains each of these functions. In other embodiments, call center 170 and web-hosting portal 160 are located in the same or different facilities.

Call center 170 contains one or more voice and data switches 172, one or more communication services managers 174, one or more communication services databases 176, one or more communication services advisors 178, and one or more network systems 180.

Switch 172 of call center 170 connects to land network 144. Switch 172 transmits voice or data transmissions from call center 170, and receives voice or data transmissions from telematics unit 120 in MVCU 110 through wireless carrier system 140, communication network 142, and land network 144. Switch 172 receives data transmissions from and sends data transmissions to one or more web-hosting portals 160. Switch 172 receives data transmissions from or sends data transmissions to one or more communication services managers 174 via one or more network systems 180.

Communication services manager 174 is any suitable hardware and software capable of providing requested communication services to telematics unit 120 in MVCU 110. Communication services manager 174 sends to or receives from one or more communication services databases 176 data transmissions via network system 180. Communication services manager 174 sends to or receives from one or more communication services advisors 178 data transmissions via network system 180. Communication services database 176 sends to or receives from communication services advisor 178 data transmissions via network system 180. Communication services advisor 178 receives from or sends to switch 172 voice or data transmissions.

Communication services manager 174 provides one or more of a variety of services, including enrollment services, navigation assistance, directory assistance, roadside assistance, business or residential assistance, information services assistance, emergency assistance, and communications assistance. Communication services manager 174 receives service-preference requests for a variety of services from the client via computer 150, web-hosting portal 160, and land network 144. Communication services manager 174 transmits user-preference and other data to telematics unit 120 in MVCU 110 through wireless carrier system 140, communication network 142, land network 144, voice and data switch 172, and network system 180. Communication services manager 174 stores or retrieves data and information from communication services database 176. Communication services manager 174 may provide requested information to communication services advisor 178.

In one embodiment, communication services advisor 178 is implemented as a real advisor. In an example, a real advisor is a human being in verbal communication with a user or subscriber (e.g. a client) in MVCU 110 via telematics unit 120. In another embodiment, communication services advisor 178 is implemented as a virtual advisor. In an example, a virtual advisor is implemented as a synthesized voice interface responding to requests from telematics unit 120 in MVCU 110.

Communication services advisor 178 provides services to telematics unit 120 in MVCU 110. Services provided by communication services advisor 178 include enrollment services, navigation assistance, real-time traffic advisories, directory assistance, roadside assistance, business or residential assistance, information services assistance, emergency assistance, and communications assistance. Communication services advisor 178 communicate with telematics unit 120 in MVCU 110 through wireless carrier system 140, communication network 142, and land network 144 using voice transmissions, or through communication services manager 174 and switch 172 using data transmissions. Switch 172 selects between voice transmissions and data transmissions.

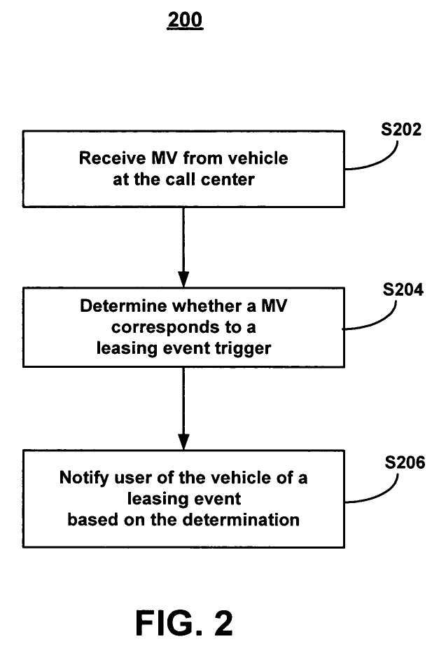

FIG. 2 a flowchart 200 representative of one embodiment of a method of operating a vehicle leasing program in accordance with the present invention. During stage S202, a mileage value (MV) is received from a leased mobile vehicle 110 at the call center 170. The mileage value is the current odometer reading from MVCU 110. The mileage value is retrieved by vehicle communication network 112 and transmitted from the telematics unit 120 via a wireless connection to the call center 170 in response to a vehicle data upload. In a vehicle data upload the call center 170 requests data from the MVCU 110 over the wireless communication system comprising one or more wireless carrier systems 140, one or more communication networks 142, one or more land networks 144.

In one embodiment, the communication services manager 174 initiates a vehicle data upload responsive to a periodic trigger. In another embodiment, a user on a web-hosting portal 160 initiates the vehicle data upload to generate input on the leased vehicle. The phrases “user of the vehicle leasing program,” “user of the mobile vehicle,” and the phrase “driver of the leased mobile vehicle” are used interchangeably throughout this document. In the discussion related to FIGS. 2-6 the term MVCU 110 refers to the leased mobile vehicle 110.

During stage S204, the communication services manager 174 determines whether the mileage value corresponds to a leasing event trigger. The communication services manager 174 determines if the mileage value exceeds a mileage threshold that is defined during a vehicle leasing program initiation. A leasing event trigger occurs, for example, when the mileage value is greater than the predetermined mileage threshold.

During stage S206, the call center 170 notifies the user of the mobile vehicle of the leasing event responsive to the determination of stage S204. If the communication services manager 174 determines the mileage value is greater than the mileage threshold, the call center 170 transmits the notification to the user. In one embodiment, notifying a user of a leasing event responsive to the determination comprises transmitting a leasing event indicator to the user.

The notification is displayed as a message on a visual display in MVCU 110. In one embodiment, the notification is a verbal message transmitted over speakers 132 in MVCU 110. In another embodiment, the notification is displayed as a message on a visual display in MVCU 110 and/or also transmitted as a verbal message over speakers 132 in MVCU 110. In another embodiment, the notification is transmitted from the call center 170 to a user-accessible web-hosting portal 160.

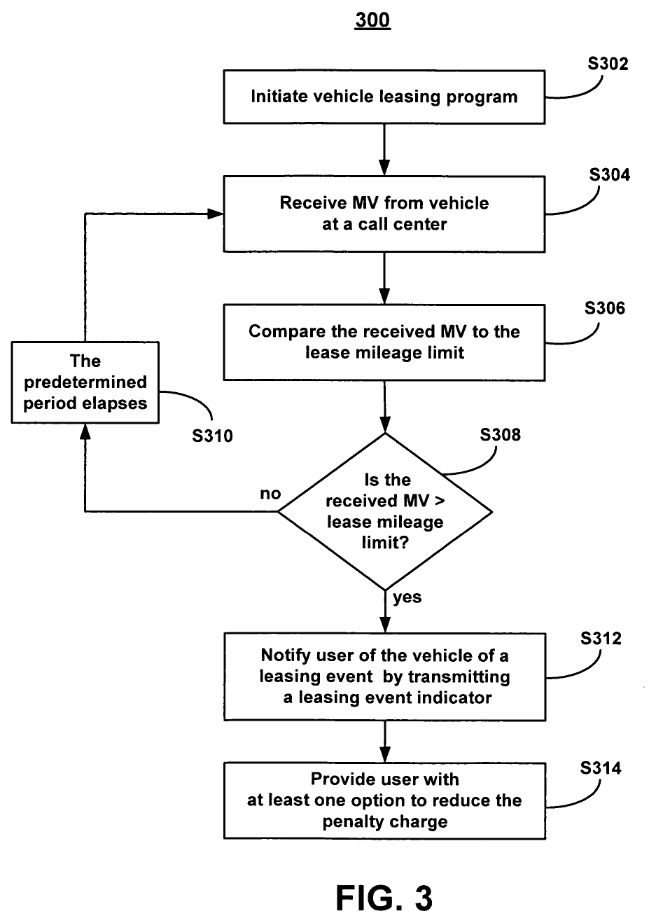

FIG. 3 illustrates a flowchart 300 representative of a method of operating a vehicle leasing program in accordance with a first embodiment the present invention. During stage S302, the vehicle leasing company initiates the vehicle leasing program for the driver of a leased mobile vehicle 110 with an installed telematics unit 120. In an alternative embodiment, the driver of a leased mobile vehicle 110 initiates the vehicle leasing program. The initiation is done, for example, using a web-hosting portal 160. In one embodiment, the initiation begins with a user action in MVCU 110 to activate the telematics unit 120, such as a button push. The user action establishes a communication with an advisor 178 at the call center 170.

During the initiation process, details about the lease contract are input to the communication services databases 176. The required lease data includes, for example, the start date of the contract, the duration of the lease, the odometer reading at the start of the lease, the lease mileage limit, the additional cost per mile for exceeding the lease mileage limit, the mileage threshold, date of the first mileage value transmission to the call center and a predetermined period for checking the mileage value on the vehicle odometer. The optional lease data includes the lease contract number and the payment schedule for the leased vehicle. The driver selects the mileage threshold, the date of first mileage value transmission and the predetermined period.

In this first embodiment, the mileage threshold is equal to the lease mileage limit. A driver who plans to drive the MVCU 110 a distance much less than the lease mileage limit might select this type embodiment. The driver in this embodiment may choose to start transmitting the mileage value to the call center 170 after three-quarters of the contract lifetime has elapsed. The predetermined period for checking the mileage threshold can be one day to many months. In one embodiment, the predetermined period changes with time with the period decreasing as the contract approaches expiration. The driver-selected parameters may be changed later if driving patterns of the driver change.

During stage S304, the call center 170 receives a mileage value (MV) from the leased mobile vehicle 110 in response to a vehicle data upload from the call center 170. In another embodiment, the MV is captured in response to a bus process or with a speech recognition automaton. The mileage value is the current reading on the odometer of the MVCU 110. The call center 170 is triggered to send the first vehicle data upload on the selected date of first mileage value transmission. During stage S306, the communication services manager 174 compares the received mileage value to the lease mileage limit. During stage S308, the communication services manager 174 determines if the received mileage value is greater than the lease mileage limit. If the received mileage value is less than the lease mileage limit, the flow proceeds to stage S310. During stage S310, the predetermined period elapses and then the flow proceeds to stage S304. The flow from stage S304 to S306 to S308 through stage S310 and back to stage S304 continues periodically until the received mileage value is greater than the lease mileage limit during stage S308. The period at which the flow repeats may be predetermined as a fixed time interval, or the period may be dynamically controlled at either the call center 170 or MVCU 110. Thus, for example, the flow may repeat on a monthly basis. Alternatively, if, for example, a driver drives over a predetermined distance on a weekly basis, the flow may be dynamically configured to operate every week.

In another embodiment, MV data is calculated in response to GPS position captured in a buffer: In one embodiment, a first GPS position is received. After a predetermined interval, such as 60 seconds, and a second GPS position is received. The first and second GPS positions are compared, and their difference is added to a distance traveled database record to approximate distance traveled by the vehicle. In another embodiment, the interval is dynamically determined such that the GPS position is recorded into the buffer for comparison when subsequent GPS positions are identical.

A leasing event trigger occurs when the received mileage value is greater than the mileage threshold. In this embodiment, the received mileage value being greater than the lease mileage limit triggers the leasing event. The flow proceeds to stage S312.

During stage S312, the call center 170 notifies the user of the mobile vehicle of the occurrence of a leasing event by transmitting a leasing event indicator responsive to the determination during stage S308. When the odometer reading exceeds the lease mileage limit the communications services manager 174 retrieves the additional cost per mile for each mile exceeding the lease mileage limit from the communication services databases 176 and calculates the additional charge that the leasing department will assess for driving the MVCU 10 up to the current mileage value. The driver is informed in the leasing event indicator of the additional charge.

During stage S314, the leasing event indicator provides the user with at least one option to reduce the additional charge related to exceeding the lease mileage limit. For example, the provided options include additional mileage purchase option, a lease-pull-ahead option, an amortization option, a lump-sum-up-front option, a current trade-off option, a lease modification option and a combination thereof. In one embodiment, the cost advantage of each provided option is also provided to the user in the leasing event indicator.

The leasing event indicator is displayed on a visual display in MVCU 110. In one embodiment, the leasing event indicator is a verbal message transmitted over speakers 132 in MVCU 110. In another embodiment, the leasing event indicator is displayed as a message on a visual display in MVCU 110 and is also transmitted as a verbal message over speakers 132 in MVCU 110. In another embodiment, the leasing event indicator is transmitted from the call center 170 to a user-accessible web-hosting portal 160.

In this described embodiment, the call center 170 monitors the mileage values using vehicle data uploads and notifies the user about the occurrence of a leasing event when the current mileage value exceeds the lease mileage limit. In one embodiment, the telematics unit 120 monitors the mileage values until the lease mileage limit is exceeded and then triggers the call center 170 to notify the user about the occurrence of a leasing event. In another embodiment, the telematics unit 120 monitors the mileage values until the lease mileage limit is exceeded and then notifies the user of the leasing event.

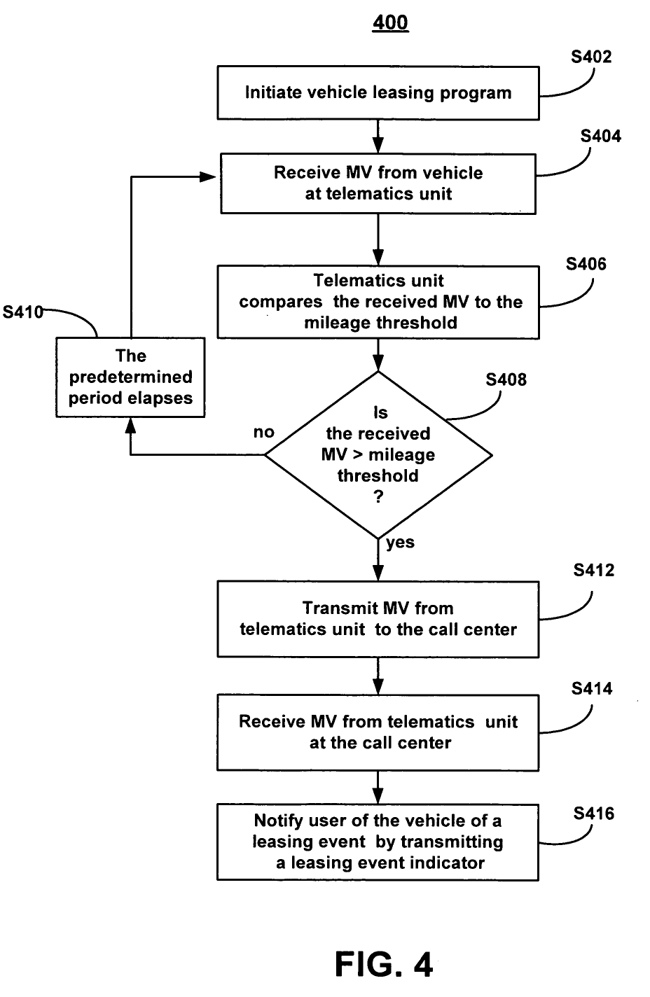

FIG. 4 illustrates a flowchart 400 representative of a method of operating a vehicle leasing program in accordance with a second embodiment of the present invention. During stage S402, the vehicle leasing company initiates the vehicle leasing program for the driver of a leased mobile vehicle 110 with an installed telematics unit 120. The initiation process is as described in flowchart 300 for stage S302 of FIG. 3 including the various embodiments.

In this second embodiment, the mileage threshold is equal to a percentage of the lease mileage limit. The driver selects the mileage threshold, the date of first mileage value transmission and the predetermined period responsive to an anticipated amount of driving.

In an exemplary initiation of the vehicle leasing program the driver chooses a mileage threshold of 75% of the lease mileage limit. The driver also chooses to have the MVCS 100 check the current mileage value with a predetermined period of one month. The driver chooses the date when the contract lifetime is half over as the date to transmit the first mileage value to the call center 170. These driver-selected parameters may be changed later if driving patterns of the driver change.

During stage S404, the telematics unit 120 receives a mileage value (MV) from the leased mobile vehicle 110. The telematics unit 120 is first triggered to read the mileage value on the date of first mileage value transmission selected during the initiation of the vehicle leasing program. The received mileage value is the current reading on the odometer of the MVCU 110. During stage S406, the telematics unit 120 compares the received mileage value to the mileage threshold. During stage S408, the telematics unit 120 determines if the received mileage value is greater than the mileage threshold. If the received mileage value is less than the mileage threshold, the flow proceeds to stage S410. During stage S410, the predetermined period elapses and then the flow proceeds back to stage S404. The flow from stage S404 to S406 to S408 through stage S410 and back to stage S404 continues until the received mileage value is determined to be greater than the mileage threshold during stage S408. The period at which the flow repeats may be predetermined as a fixed time interval, or the period may be dynamically controlled at either the call center 170 or MVCU 110. Thus, for example, the flow may repeat on a monthly basis. Alternatively, if, for example, a driver drives over a predetermined distance on a weekly basis, the flow may be dynamically configured to operate every week.

When the received mileage value is greater than the mileage threshold, a leasing event is triggered and the flow proceeds to stage S412. During stage S412, the telematics unit 120 transmits the mileage value to the call center 170. During one embodiment, the mileage value is transmitted via a wireless connection established by the telematics unit 120 over one or more wireless carrier systems 140, one or more communication networks 142, one or more land networks 144.

During stage S414, the call center 170 receives the mileage value from the telematics unit 120. During stage S416, the call center 170 notifies the user of the mobile vehicle of a leasing event by transmitting a leasing event indicator to the user. The leasing event indicator informs the user that the odometer reading is the selected percentage of the lease mileage limit. The leasing event indicator is displayed or announced as described for stage S314 of flowchart 300 in FIG. 3 including the various embodiments.

In this described embodiment, telematics unit 120 monitors the mileage values until a selected percent of the lease mileage limit is exceeded and then the call center 170 notifies the user about the occurrence of a leasing event. In one embodiment, the telematics unit 120 monitors the mileage values until a selected percent of the lease mileage limit is exceeded and then the telematics unit 120 notifies the user about the occurrence of a leasing event. In another embodiment, the call center 170 monitors the mileage values using vehicle data uploads and notifies the user about the occurrence of a leasing event when the current mileage value exceeds the selected percent of the lease mileage limit.

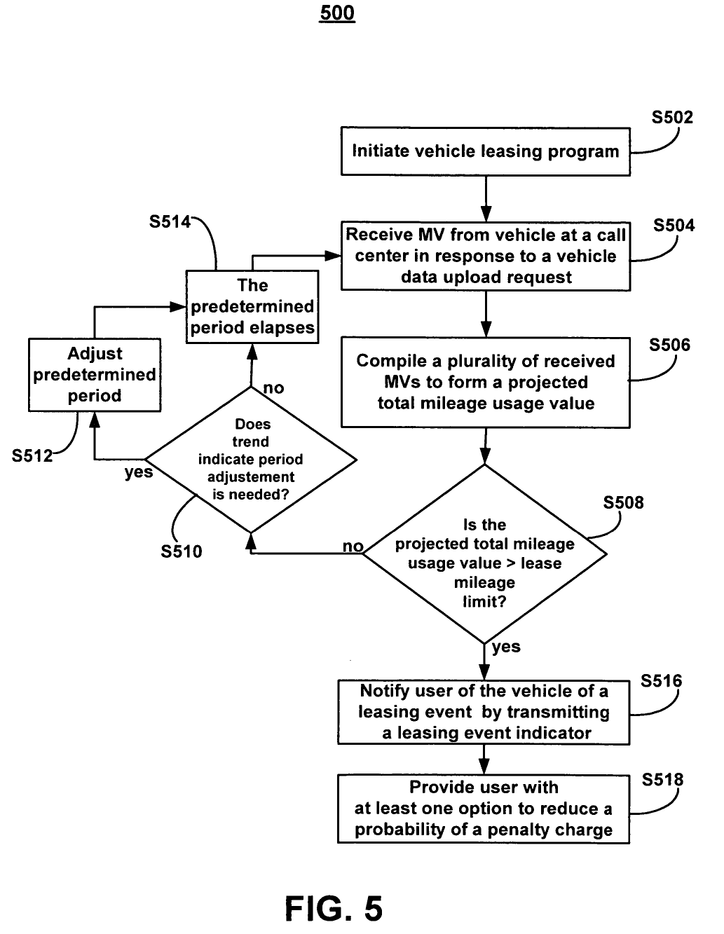

FIG. 5 illustrates a flowchart 500 representative of a method of operating a vehicle leasing program in accordance with a third embodiment of the present invention. During stage S502, the vehicle leasing company initiates the vehicle leasing program for the driver of a leased mobile vehicle 110 with an installed telematics unit 120. The initiation process is as described in flowchart 300 for stage S302 of FIG. 3 including the various embodiments.

In this third embodiment, the mileage threshold is a projected total mileage usage value. The projected total mileage usage value is responsive to an extrapolation of the mileage accumulation on the MVCU 110 throughout the duration of the leasing contract. The driver in this third embodiment chooses to start transmitting the mileage value to the call center 170 within days or weeks after the contract begins. The driver in this third embodiment chooses a predetermined period for checking the mileage threshold of a few days to a week. This relatively short period allows the call center 170 to establish driving trends from the beginning of the contract.

During stage S504, the call center 170 receives a mileage value (MV) from the leased mobile vehicle 110 in response to a vehicle data upload from the call center 170. The mileage value is the current reading on the odometer of the MVCU 110. The call center 170 was triggered to send the first vehicle data upload on the selected date of first mileage value transmission. During stage S506, the communication services manager 174 compiles a plurality of received mileage values to form a projected total mileage usage value. The plurality of the received mileage values includes all the previously received mileage values and the last received mileage value. The first received mileage value is the first value in the compilation. The communication services manager 174 extrapolates the compiled plurality of received mileage values versus time from the start of the contract to the end of the contract to calculate a projected total mileage usage value.

During stage S508, the communication services manager 174 determines if the projected total mileage usage value is greater than the lease mileage limit. If the projected total mileage usage value is less than the lease mileage limit, the flow proceeds to stage S510.

During stage S510, the communication services manager 174 determines if the driving trend indicates that the predetermined period needs adjustment. The driving trend is recognized responsive to the compiled plurality of received mileage values. If the driver of the MVCU 110 drives about the same number of miles per week over several contiguous weeks, the trend is recognized to be consistent and the period increases. In an exemplary vehicle leasing program, an initial period of three days increases to a new period of four weeks when the trend is consistent. The phrase “about the same numbers of miles” is defined to be within a portion of a defined standard deviation of numbers of miles.

Alternatively, the miles driven per week differ radically over several contiguous weeks. The phrase “differ radically” is defined to be outside a portion of a defined standard deviation of numbers of miles. In this case, the trend is recognized to be inconsistent and the period remains the same or perhaps decreases from the initial period to several weeks. In one embodiment of a vehicle leasing program, an initial period of three days is reduced to a new period of one day when the trend is inconsistent.

If it is determined, during stage S510, that the trend indicates a period adjustment is needed, the flow proceeds to stage S512. During stage S512, the communication services manager 174 adjusts the predetermined period responsive to the statistics of the compiled plurality of received mileage values. The flow proceeds to stage S514.

If it is determined, during stage S510, that the trend indicates a period adjustment is not needed, the flow proceeds to stage S514.

During stage S514, the predetermined period elapses and then the flow proceeds to stage S504. The flow cycles through stages S504-S508 through stages S510, S514, and possibly S512 as needed, coming back to stage S504. The flow cycle continues until it is determined, during stage S508, that the projected total mileage usage value is greater than the lease mileage limit.

When the projected total mileage usage value is greater than the lease mileage limit the flow proceeds to stage S516. During stage S516, the call center 170 notifies the user of the mobile vehicle of a leasing event by transmitting a leasing event indicator responsive to the determination during stage S508. In this embodiment the projected total mileage usage value being greater than the lease mileage limit comprises the leasing event. The communications services manager 174 retrieves the additional cost information, such as additional cost per mile, for miles exceeding the lease mileage limit from the communication services databases 176 and calculates the expected additional charges responsive to the projected total mileage usage value. The expected additional charge is the difference between projected total mileage usage value and the lease mileage limit times the additional cost per mile in excess of the lease mileage limit. The driver is informed of the expected additional charge in the leasing event indicator. During stage S518, the leasing event indicator provides the user with at least one option to reduce the expectation of an additional charge related to potentially exceeding the lease mileage limit. The options include additional mileage purchase option, a lease-pull-ahead option, an amortization option, a lump-sum-up-front option, a current trade-off option, a lease modification option and a combination thereof. The cost advantage of each provided option is also provided to the user in the leasing event indicator. The leasing event indicator is displayed or announced as described for stage S314 of flowchart 300 in FIG. 3 including the various embodiments.

In this described embodiment, the call center 170 monitors the mileage values using vehicle data uploads and notifies the user of a leasing event when the projected total mileage usage value exceeds the lease mileage limit. In one embodiment, the telematics unit 120 monitors the mileage values until the projected total mileage usage value exceeds the lease mileage limit and then triggers the call center 170 to notify the user of the leasing event. In another embodiment, the telematics unit 120 monitors the mileage values until the projected total mileage usage value exceeds the lease mileage limit and then notifies the user of the leasing event.

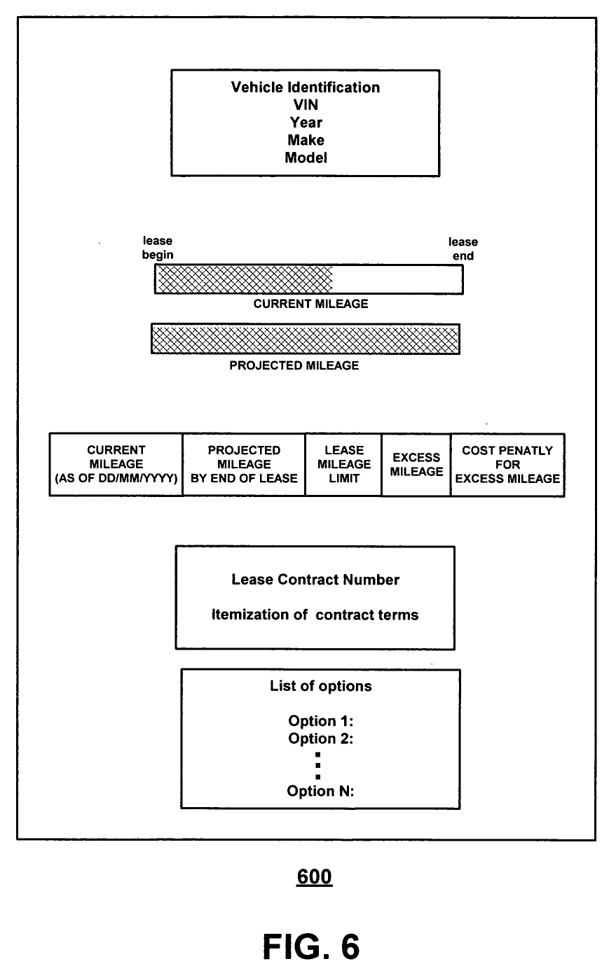

FIG. 6 illustrates a block diagram of a leasing event indicator 600 in accordance with the third embodiment of FIG. 5. The leasing event indicator comprises the vehicle information, as well as the current mileage, projected mileage by the end of the lease, the lease mileage limit, the excess mileage, which is the difference between projected total mileage usage value and the lease mileage limit. The additional cost for the excess mileage is also listed in the leasing event indicator. The lease contract number, itemization of the contract terms and the list of options are also in the leasing event indicator.

The contract terms include the start date of the contract, the duration of the lease, the odometer reading at the start of the lease, the additional cost per mile for exceeding the lease mileage limit, and the payment schedule for the leased vehicle or any combination thereof.

The user of the mobile vehicle sees a bar indicator of the current mileage and the projected mileage. The user monitors this information at any time by doing a button push on the telematics unit 120 or by accessing the MVCS 100 on a computer via the web-hosting portal 160.

In one embodiment, a user who participates in sequential vehicle leasing programs for sequentially leased vehicles has a user-lease-profile from one or more previously leased vehicles linked with the user-lease-profile being developed in a currently leased vehicle. A user's preference in choosing options is included in the linked user lease profiles to prioritize the options for the user in a subsequent leasing event indicator.

While the embodiments of the invention disclosed herein are presently considered to be preferred, various changes and modifications can be made without departing from the spirit and scope of the invention. The scope of the invention is indicated in the appended claims, and all changes that come within the meaning and range of equivalents are intended to be embraced therein.

What is claimed is:

1. A method of operating a vehicle leasing program, the method comprising:
receiving a mileage value from a vehicle at a call center;
determining whether the mileage value corresponds to a leasing event trigger; and
notifying a user of the vehicle of a leasing event responsive to the determination.

2. The method of claim 1, wherein the mileage value is transmitted via a wireless connection from a telematics unit of the vehicle.

3. The method of claim 1, wherein determining whether the mileage value corresponds to a leasing event trigger comprises:
comparing the received mileage value to a lease mileage limit associated with the vehicle.

4. The method of claim 1, further comprising:
transmitting the mileage value from the vehicle to the call center when a mileage threshold is exceeded.

5. The method of claim 1, wherein the mileage value comprises a compilation of a plurality of mileage values received in response to a respective plurality of vehicle upload data requests periodically transmitted from the call center to the vehicle.

6. The method of claim 5, wherein a period of the transmitted plurality of vehicle upload data requests is responsive to a trend in the compilation of the plurality of mileage values.

7. The method of claim 1, wherein determining whether the mileage value corresponds to a leasing event trigger comprises;
comparing a last received mileage value to a lease mileage limit associated with the vehicle;
extrapolating a compilation of a plurality of received mileage values to form a projected total mileage usage value; and
comparing the projected total mileage usage value to the lease mileage limit.

8. The method of claim 1, wherein the notifying a user of the vehicle of a leasing event responsive to the determination comprises:
transmitting a leasing event indicator to the user.

9. The method of claim 8, wherein the leasing event indicator comprises at least one option to reduce an additional charge related to exceeding a lease mileage limit.

10. The method of claim 8, wherein the leasing event indicator comprises at least one option to reduce a expectation of an additional charge related to a projected total mileage usage value exceeding a lease mileage limit.

11. The method of claim 10, wherein the at least one option to reduce the expectation of the additional charge is selected from the group consisting of an additional mileage purchase option, a lease-pull-ahead option, an amortization option, a lump-sum-up-front option, a current trade-off option, a lease modification option and a combination thereof.

12. A vehicle leasing system, comprising:
means for receiving a mileage value from a vehicle at a call center;
means for determining whether the mileage value corresponds to a leasing event trigger; and
means for notifying a user of the vehicle of a leasing event responsive to the determination.

13. A computer readable medium storing a computer program comprising:
computer readable code for receiving a mileage value from a vehicle at a call center;
computer readable code for determining whether the mileage value corresponds to a leasing event trigger; and
computer readable code for notifying a user of the vehicle of a leasing event responsive to the determination.

14. The medium of claim 13, wherein computer readable code transmits the mileage value via a wireless connection from a telematics unit of the vehicle.

15. The medium of claim 13, wherein computer readable code for determining whether the mileage value corresponds to a leasing event trigger comprises:
computer readable code for comparing the received mileage value to a lease mileage limit associated with the vehicle.

16. The medium of claim 13, further comprising:
computer readable code for transmitting the mileage value from the vehicle to the call center when a mileage threshold is exceeded.

17. The medium of claim 13, wherein computer readable code compiles a plurality of mileage values received in response to a plurality of vehicle upload data requests periodically transmitted by computer readable code from the call center to the vehicle.

18. The medium of claim 13, wherein computer readable code for determining whether the mileage value corresponds to a leasing event trigger comprises;
computer readable code for comparing a last received mileage value to a lease mileage limit associated with the vehicle; and
computer readable code for extrapolating a compilation of a plurality of received mileage values to form a projected total mileage usage value; and
computer readable code for comparing the projected total mileage usage value to the lease mileage limit.

19. The medium of claim 13, wherein computer readable code for notifying a user of the vehicle of a leasing event responsive to the determination comprises:
computer readable code for transmitting a leasing event indicator to the user.

20. The medium of claim 19, wherein computer readable code for transmitting the leasing event indicator comprises computer readable code for at least one option to reduce an expectation of an additional charge related to a projected total mileage usage value exceeding a lease mileage limit.
